(19) United States
(12) Patent Application Publication
(10) Pub. No.: US 2006/0096156 A1
(43) Pub. Date: May 11, 2006

(54) System and method for suspending fishing bait

(76) Inventor: Marco Griffero, St. Louis, MO (US)

Correspondence Address: SPENCER, FANE, BRITT & BROWNE, 1000 WALNUT STREET, SUITE 1400, KANSAS CITY, MO, 64106-2140, US

(21) Appl. No.: 10/983,838

(22) Filed: Nov. 8, 2004

(51) Int. Cl. A01K 83/00; A01K 83/06

(52) U.S. Cl. 43/43.16; 43/44.8

(57) ABSTRACT

A method and apparatus for suspending a baited hook is provided which includes a fishing rig comprising: a bait hook having, a shank, a line attachment at the end of said shank, a shank extension having a line attachment at one end, wherein said shank extension overlaps said hook shank and is rigidly fastened thereto; and at least one float connected along said shank extension. A method for making a fishing rig is provided wherein the method comprises the steps of: providing a bait hook having a shank, a line attachment at the end of said shank; attaching a shank extension to said hook shank so that said shank extension overlaps said hook shank and is rigidly attached thereto; and attaching at least one float to said shank extension.

### CROSS REFERENCE TO RELATED APPLICATIONS

None.

### STATEMENT REGARDING FEDERALLY SPONSORED RESEARCH AND DEVELOPMENT

None.

### BACKGROUND OF THE INVENTION

The present invention relates generally to fishing rigs. More particularly, the present invention relates to fishing rigs that keep a hook and bait combination suspended above the bottom of a body of water.

When angling for certain types of fish, such as bass, walleye, catfish, or other fish, it is often advantageous to use a fishing rig adopted for proper presentation of the bait and hook to the fish. One such rig is known as a “Carolina” rig, which is a type of “weedless” rig. Generally, a conventional Carolina rig is made of a piece of relatively long flexible leader line where one end of the leader line is connected to a fishing hook and the other end is connected to a fishing line using a swivel. A weight is attached to the fishing line on the other side of the swivel. The head of a plastic worm is placed over the shank of the hook, and the body of the worm receives the hook barb.

Despite its popularity, conventional Carolina rigs have several disadvantages which are often encountered in its use. One disadvantage of the conventional Carolina rig is that it has a tendency to get snagged on underwater objects such as logs, rocks or underwater brush when it is reeled in. This is due to the fact that the hook and bait get dragged behind the sinker along the bottom of the lake. Once caught on an underwater object, the rig is often lost because the fishing line is often broken when the Angler tries to pull the rig free. Once the line has been broken, a new rig, if one is available, must be fastened to the fishing line before fishing can continue. Unfortunately, it is not uncommon to lose many of these rigs during each day of fishing. Even when the entire rig is not lost by getting hung up on an underwater object, the bait is often lost as a result of getting tangled up. Another drawback to dragging bait along the bottom of the lake is that doing so does not make the bait very visible to the fish.

Prior approaches have attempted to address the entanglement issue by attaching a float onto the leader line near the hook and bait. These are sometimes referred to as Carolina Floaters. The Carolina Floater device consists of a small float which is slideably attached onto the leader line. A disadvantage of this and other approaches using floats thus far is that the float inevitably gets separated from the bait and the rig gets snagged on an underwater object.

### BRIEF SUMMARY OF THE INVENTION

There is, therefore, provided in the practice of the invention a novel fishing rig. In accordance with one embodiment of the present invention, a fishing rig is provided that includes a bait hook having a shank, a line attachment adjacent to the end of the shank, and at least one float connected along the shank. Another apparatus according to an embodiment of the present invention provides a fishing rig that includes a bait hook having a shank, a line attachment on the end of the shank, at least one float connected along the shank, where the shank includes the line attachment, a substantially straight portion, an elbow bend, and a curved portion and a point. In accordance with another embodiment according to the present invention is provided where a fishing has the aforementioned features and advantages and further includes a bait pin, wherein the bait pin is connected to the shank and the at least one float interposes the line attachment and the bait pin.

In accordance with still another embodiment of the present invention, a novel fishing rig is provided that includes a hook having a shank, a first line attachment at the end of the shank, a second line attachment along the shank and at least one float connected to the second line attachment.

In accordance with yet another embodiment of the present invention a novel fishing rig is provided which a bait hook having a shank, a line attachment at the end of the shank, a shank extension having a line attachment at one end, wherein the shank extension overlaps with the hook shank and is rigidly fastened thereto where at least one float is connected along the shank extension. Another embodiment is provided that includes the aforementioned features and further includes a bait pin, where the bait pin is connected to the bait hook line attachment.

In accordance with still another aspect of the present invention, a method of making a fishing rig is provided which includes the steps of providing a bait hook having a shank and a line attachment at the end of the shank, attaching a shank extension to the hook shank so that the shank extension overlaps the hook shank and is rigidly attached thereto and attaching at least one float to the shank extension. In accordance with yet another aspect of the present invention, a method of making a fishing rig is provided which includes the steps of providing a bait hook having a shank and a line attachment at the end of the shank, attaching a tether to the shank so that the tether is rigidly attached thereto; and attaching at least one float to the tether.

Accordingly, it is an object of the present invention to provide an improved fishing rig. There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### BRIEF DESCRIPTION OF THE DRAWINGS

Further features of the present invention will become apparent to those skilled in the art to which the present invention relates from reading the following description with reference to the accompanying drawings, in which:

FIG. 1 is a side schematic illustration of a fishing rig attached to a fishing line in operative position on the bottom surface of a body of water.

FIG. 2 is a side schematic illustration of a fishing rig according to a preferred embodiment of the present invention, attached to a fishing line in operative position in a body of water.

FIG. 3 is an enlarged perspective view of a single float fishing rig according to a preferred embodiment of the present invention.

FIG. 4 is an enlarged perspective view of a single float fishing rig according to an alternate preferred embodiment of the present invention featuring a cutaway view of the float.

FIG. 5 is an enlarged perspective view of a single float fishing rig according to an alternate preferred embodiment of the present invention featuring a cutaway view of the float.

FIG. 6 is an enlarged perspective view of a single float fishing rig according to an alternate preferred embodiment of the present invention featuring a cutaway view of the float.

FIG. 7 is an enlarged perspective view of a single float fishing rig according to an alternate preferred embodiment of the present invention.

FIG. 8 is an enlarged perspective view of a multiple float fishing rig according to an alternate preferred embodiment of the present invention.

FIG. 9 is an enlarged perspective view of a multiple float fishing rig according to an alternate preferred embodiment of the present invention.

FIG. 10 is an enlarged perspective view of a multiple float fishing rig according to an alternate preferred embodiment of the present invention.

FIG. 11 is an enlarged perspective view of a single float fishing rig according to an alternate preferred embodiment of the present invention featuring a cutaway view of the float.

FIG. 12 is an enlarged perspective view of a multiple float fishing rig according to an alternate preferred embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not been maintained in the Figures. Instead, the sizes of certain small components have been exaggerated for illustration. An embodiment in accordance with the present invention provides an apparatus for suspending a fishing rig and bait above the bottom of a body of water. The inventive fishing rig suspends the bait and hook from the bottom of the lake which reduces the likelihood of the bait becoming entangled on an underwater object and lost. Another aspect of the invention includes a method of making a fishing rig that is operable to suspend bait from the bottom of a lake or other body of water.

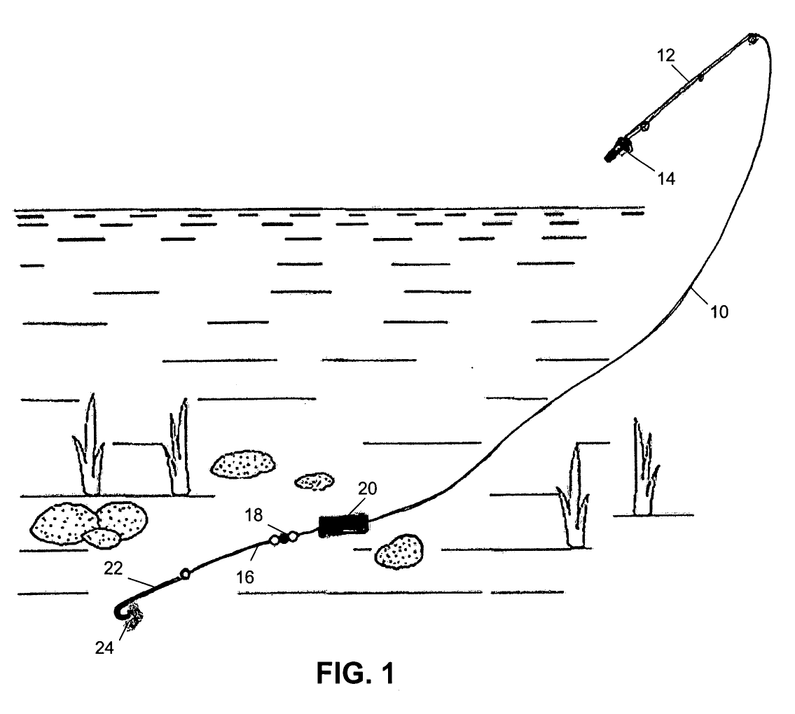

FIG. 1 shows a side schematic illustration of a fishing rig attached to a fishing line 10 in operative position on the bottom surface of a body of water. One end of the fishing line 10 is attached to a fishing rod 12 having a casting type reel 14. The other end of the fishing line 10 is attached to a first end of a leader line 16 using a swivel 18. A bullet-shaped weight 20 is attached to slide along the fishing line 10 and is bounded by the swivel 18. The second end of the leader line 16 is attached a fishing hook 22 and bait 24. As previously mentioned, this conventional rig does not suspend the bait from the bottom of the lake and is susceptible to getting entangled on underwater objects.

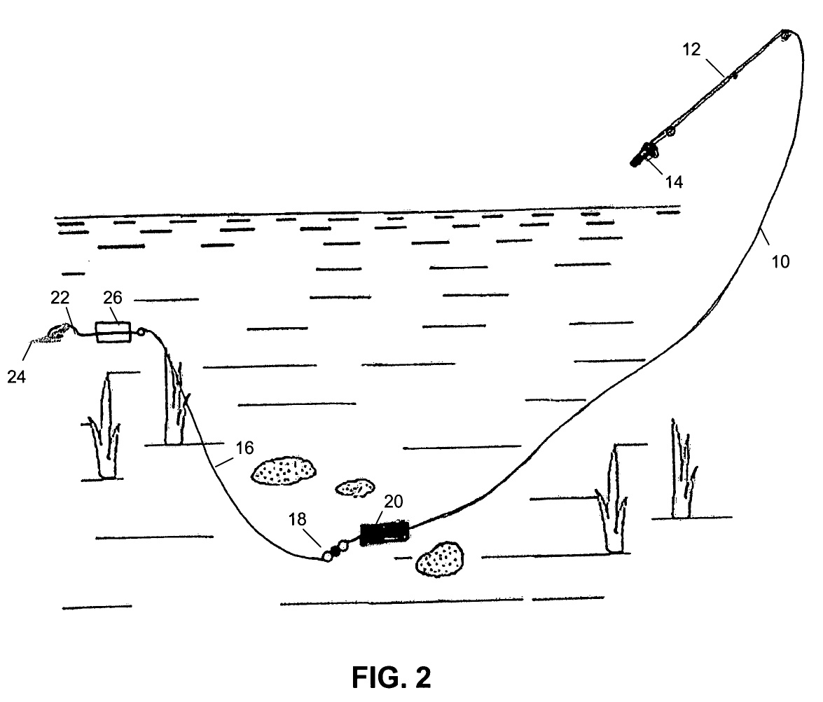

Turning now to FIG. 2, shown is a side schematic illustration of a fishing rig according to a preferred embodiment of the present invention, attached to a fishing line 10 in operative position suspended off of the bottom of a body of water. One end of the fishing line 10 is attached to a fishing rod 12 having a casting type reel 14. The other end of the fishing line 10 is attached to a first end of a leader linel6 using a swivel 18. A bullet-shaped sinker 20 is attached to the fishing line 10 in a manner that permits the sinker 20 to slide along the fishing line 10 and is bounded by the swivel 18. The second end of the leader line 16 is attached a fishing hook 22 with bait 24. A float 26 is attached along the shank of the hook 22.

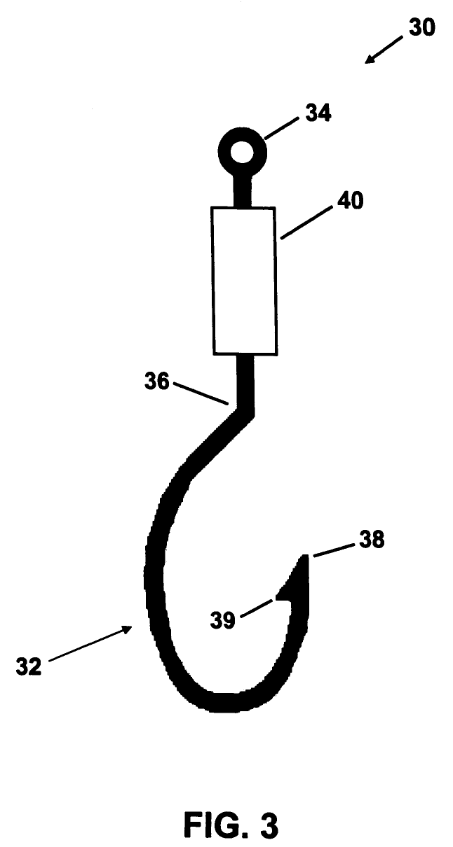

FIG. 3 is an enlarged perspective view of a single float fishing rig according to a preferred embodiment of the present invention. The fishing rig 30 includes a fishing hook 32. The hook 32 may be a bait hook or other type of bait hook. The hook 32 features a line attachment 34, a shank 36, a point 38, and a barb 39. The shank 36 features a substantially straight shaped portion starting with the line attachment 34, followed by a bend, which is then followed by a curve shaped portion which continues all the way to the point 38 of the hook. The fishing rig 30 also includes a float 40 which surrounds the substantially straight shaped portion of the shank 36. As pictured, the substantially straight shaped portion of the shank 36 is elongated.

In a preferred embodiment, the float 40 is constructed of closed cell polyethylene foam, however, any lightweight buoyant material may be used. Closed cell polyethylene foam is that it is highly resistant to water absorption and features excellent tear and tensile strength. Additionally, the float may be constructed from a particular color of foam or painted one or more colors, such as red, black, blue, white, sliver, or yellow. According to some anglers, certain colors aid in attracting fish. Some embodiments of the invention feature floats with a generally streamlined shape. The floats may also be frustoconical, trapezoidal, or irregularly shaped. An advantage of attaching the float directly to the shank of the hook is that the float does not become separated from the hook 32 or bait. Another advantage of attaching the float 40 to the shank 36 is that the float tends to suspend the bait and hook 32 from the bottom of a lake in a horizontal orientation with respect to the bottom of the lake. A horizontal orientation is desirable since it presents the bait to the fish in a visible, natural fashion. When using certain kinds of bait such as stink bait, a further advantage to a horizontal orientation may be appreciated in that the bait scent can be spread over broader area than would be possible using prior rigs that position the bait on the bottom of the lake and do not suspend the bait in a generally horizontal orientation.

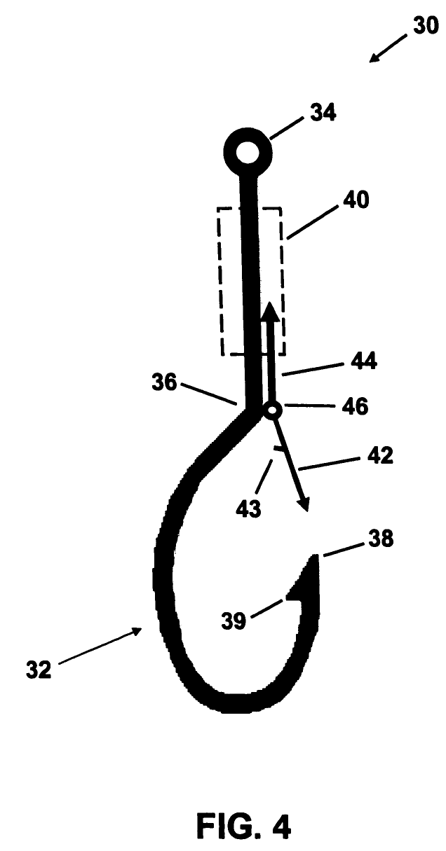

FIG. 4 is an enlarged perspective view of a single float fishing rig according to an alternate preferred embodiment of the present invention featuring a cutaway view of the float. The fishing rig 30 includes a fishing hook 32 that features a line attachment 34, a shank 36, a point 38, and a barb 39. The shank 36 features a substantially straight shaped portion starting with the line attachment 34, followed by a bend, which is then followed by a curve shaped portion which continues all the way to the point 38 of the hook. The fishing rig 30 also includes a float 40 which surrounds the substantially straight shaped portion of the shank 36. As pictured, the substantially straight shaped portion of the shank 36 is elongated. The fishing rig 30 further includes a bait pin 42 which is pivotably mounted to a auxiliary anchor pin 44 via an auxiliary line attachment 46. The bait pin 42 is mounted near the portion of the shank 36 so it may span the area between the shank 36 and the point 38 of the hook 32. In a preferred embodiment, the bait pin 42 may feature one or more barbs 43. In other embodiments the bait pin 42 may feature bumps, ridges or have a spring or corkscrew configuration.

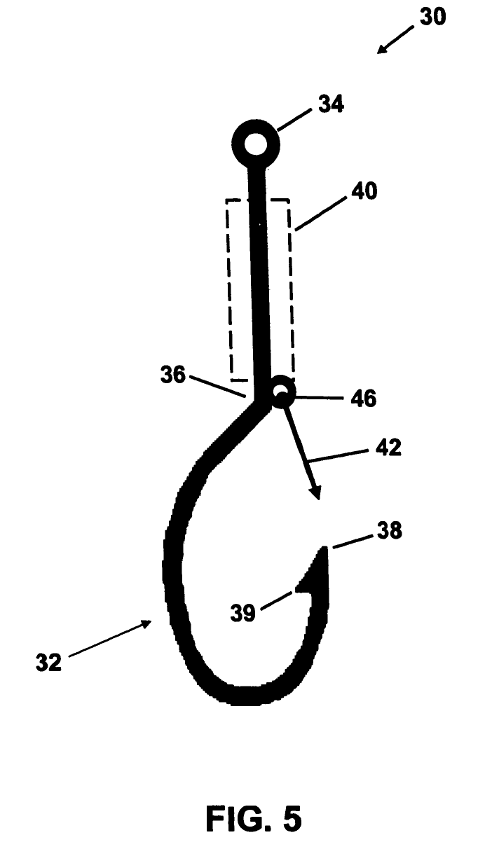

FIG. 5 is an enlarged perspective view of a single float fishing rig according to an alternate preferred embodiment of the present invention featuring a cutaway view of the float. The fishing rig 30 includes a fishing hook 32 which features a line attachment 34, a shank 36, a point 38, and a barb 39. The shank 36 features a substantially straight shaped portion starting with the line attachment 34, followed by a bend, which is then followed by a curve shaped portion which continues all the way to the point 38 of the hook. The fishing rig 30 also includes a float 40 which surrounds the substantially straight shaped portion of the shank 36. As pictured, the substantially straight shaped portion of the shank 36 is elongated. The fishing rig 30 further includes a bait pin 42 which is pivotably mounted to the shank 36 via an auxiliary line attachment 46. The bait pin 42 is mounted near the portion of the shank 36 to span to the point 38.

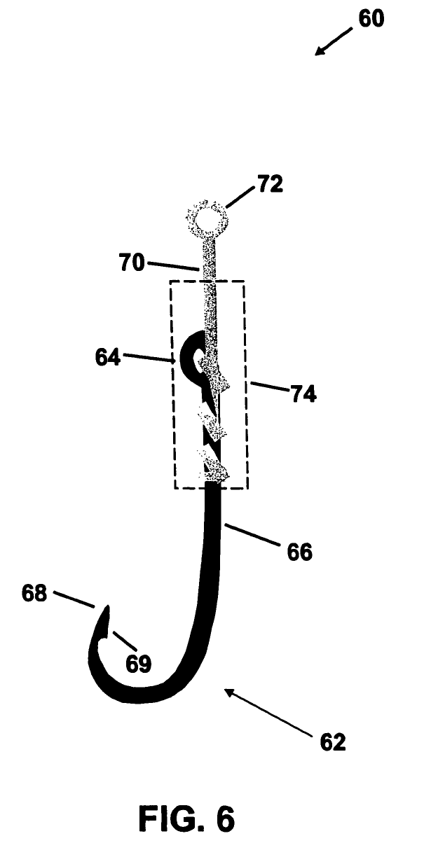

FIG. 6 is an enlarged perspective view of a single float fishing rig according to an alternate preferred embodiment of the present invention featuring a cutaway view of the float. The fishing rig 60 includes a fishing hook 62 that features a line attachment 64, a shank 66, a point 68, and a barb 69. The fishing rig 60 also includes a shank extension 70 which is wrapped through the line attachment 64 and around the shank 66 of the hook 62. The shank extension 70 further includes a shank extension line attachment 72. The fishing rig 60 includes a float 74 which surrounds the straight portion of the shank 66 and the portion of the shank extension 70 which overlaps the shank 66.

According to a preferred embodiment, the shank extension 70 is comprised of stainless steel wire, however, any wire with suitable strength may be used. It may be desirable to wrap the shank extension 70 through the hook line attachment 64 of the hook so the hook 62 and the shank extension 70 are rigidly connected.

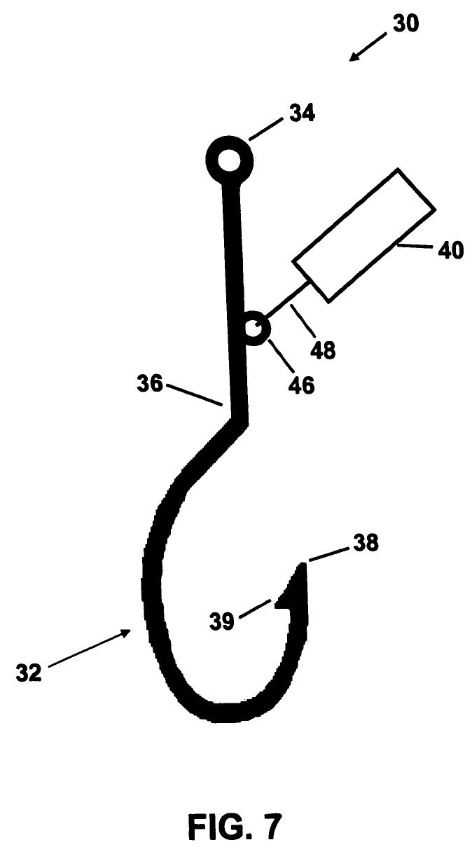

FIG. 7 is an enlarged perspective view of a single float fishing rig according to an alternate preferred embodiment of the present invention. The fishing rig 30 includes a fishing hook 32 which features a line attachment 34, a shank 36, a point 38, and a barb 39. The shank 36 features a substantially straight shaped portion starting with the line attachment 34, followed by a bend, which is then followed by a curve shaped portion which continues all the way to the point 38 of the hook. As pictured, the substantially straight shaped portion of the shank 36 is elongated. The fishing rig 30 further includes a float 40 which is connected to an auxiliary line attachment 46 mounted along the shank 36 via a tether 48. The tether 48 may be constructed of wire, fishing line or any other material that will secure the float 40 to the auxiliary line attachment 46.

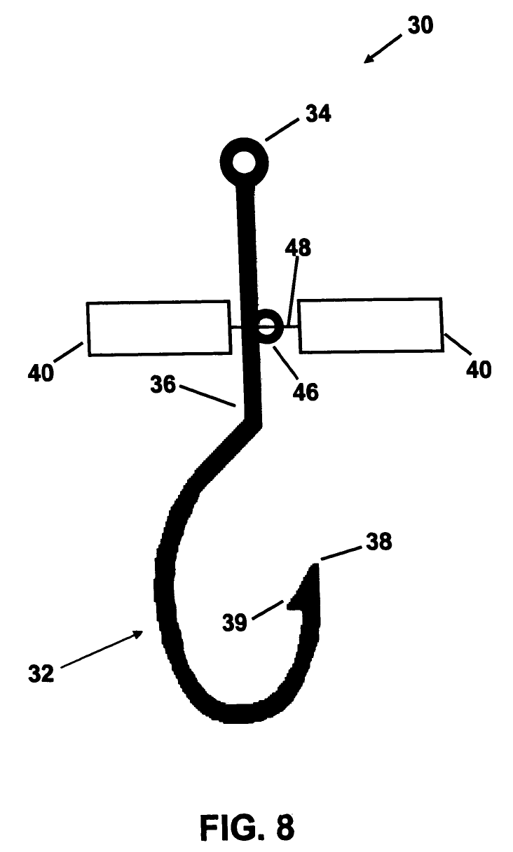

FIG. 8 is an enlarged perspective view of a multiple float fishing rig according to an alternate preferred embodiment of the present invention. The fishing rig 30 includes a fishing hook 32 which features a line attachment 34, a shank 36, a point 38, and a barb 39. The shank 36 features a substantially straight shaped portion starting with the line attachment 34, followed by a bend, which is then followed by a curve shaped portion which continues all the way to the point 38 of the hook. As pictured, the substantially straight shaped portion of the shank 36 is elongated. The fishing rig 30 further includes two identical floats 40 which are connected to an auxiliary line attachment 46 mounted on the shank 36 via a tether 48.

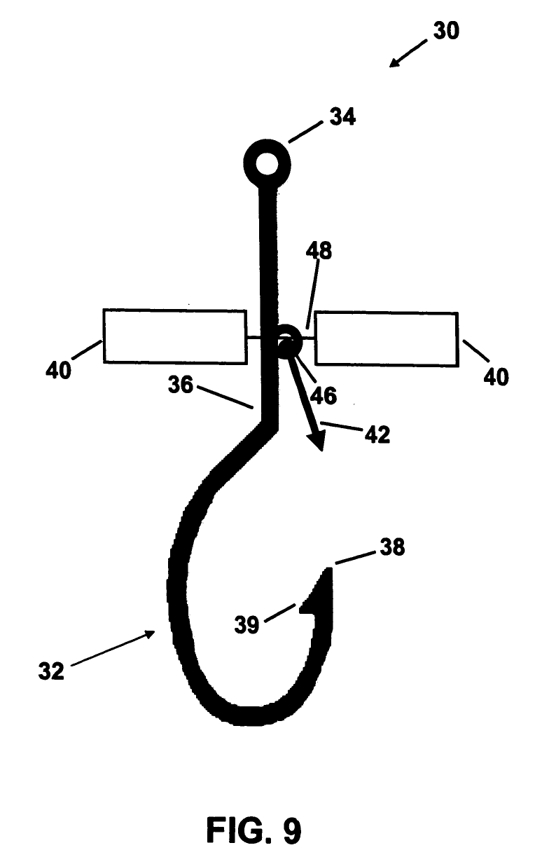

FIG. 9 is an enlarged perspective view of a multiple float fishing rig according to an alternate preferred embodiment of the present invention. The fishing rig 30 includes a fishing hook 32 that features a line attachment 34, a shank 36, a point 38, and a barb 39. The shank 36 features a substantially straight shaped portion starting with the line attachment 34, followed by a bend, which is then followed by a curve shaped portion which continues all the way to the point 38 of the hook. As pictured, the substantially straight shaped portion of the shank 36 is elongated. The fishing rig 30 further includes a bait bin 42 which is pivotably connected to an auxiliary line attachment 46 mounted on the shank 36. The bait pin 42 is mounted near the portion of the shank 36 to span to the point 38. The fishing rig 30 further includes two identical floats 40 which are connected to an auxiliary line attachment 46 mounted on the shank 36 via a tether 48.

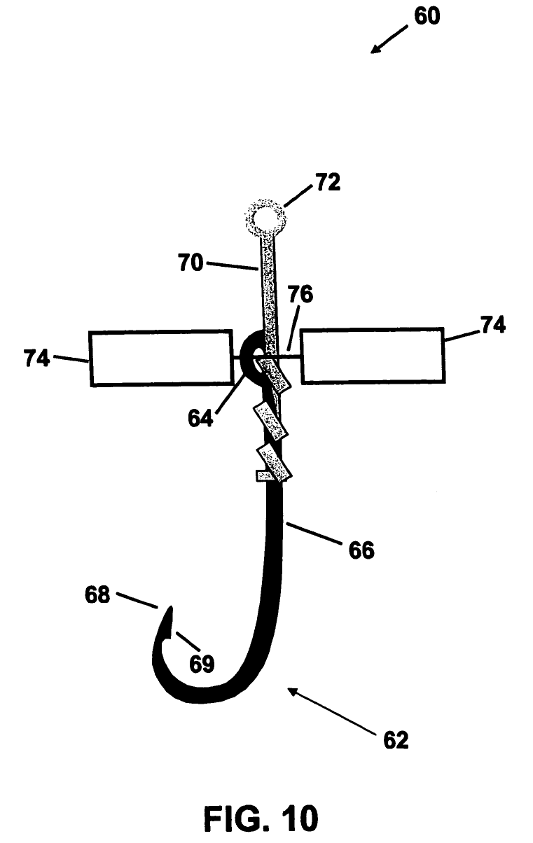

FIG. 10 is an enlarged perspective view of a multiple float fishing rig according to an alternate preferred embodiment of the present invention. The fishing rig 60 includes a fishing hook 62 that features a line attachment 64, a shank 66, a point 68, and a barb 69. The fishing rig 60 also includes a shank extension 70 which is wrapped through the line attachment 64 and around the shank 66 of the hook 62. The shank extension 70 further includes a shank extension line attachment 72. The fishing rig 60 further includes two identical floats 74 which are connected to the line attachment 64 via a tether 76.

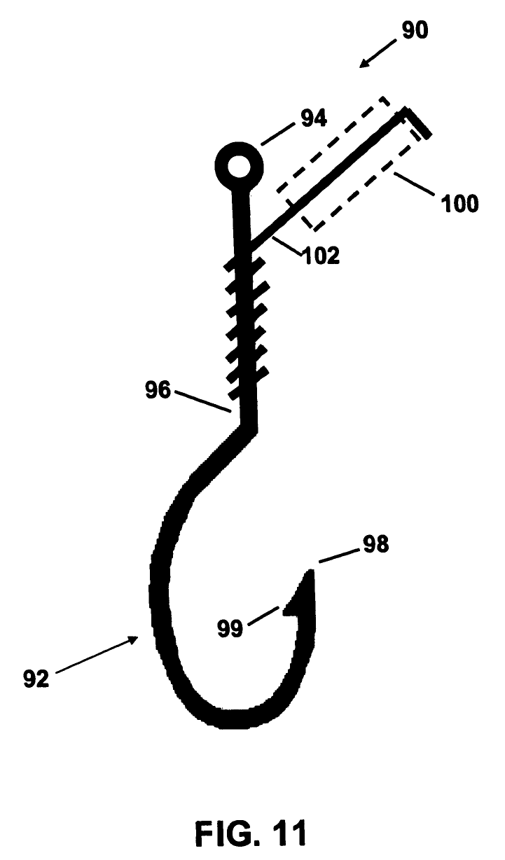

FIG. 11 is an enlarged perspective view of a single float fishing rig according to an alternate preferred embodiment of the present invention having the float in a desired location illustrated by dashed lines. The fishing rig 90 includes a fishing hook 92 which features a line attachment 94, a shank 96, a point 98, and a barb 99. The shank 96 features a substantially straight shaped portion starting with the line attachment 94, followed by a bend, which is then followed by a curve shaped portion which continues all the way to the point 98 of the hook 92. As pictured, the substantially straight shaped portion of the shank 96 is elongated. The fishing rig 90 further includes a float 100 which is connected to the shank 96 via a tether 102 which is wrapped around the shank 96.

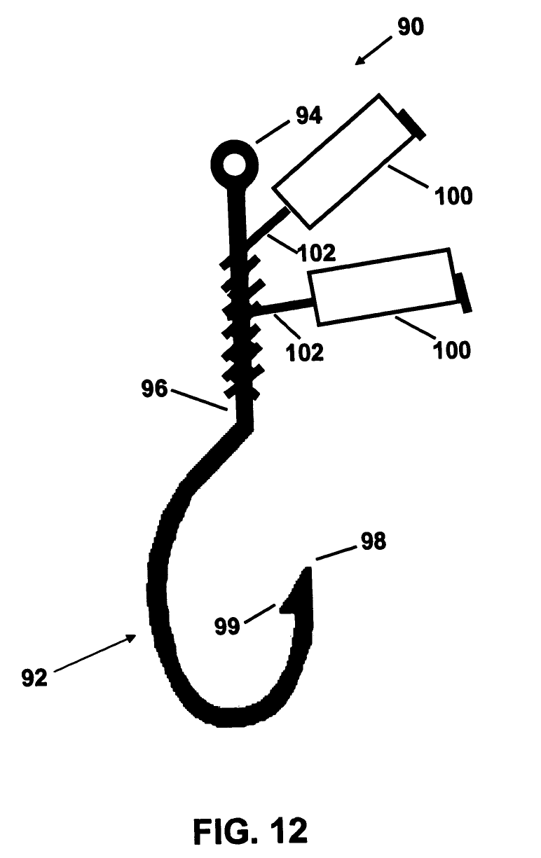

FIG. 12 is an enlarged perspective view of a multiple float fishing rig according to an alternate preferred embodiment of the present invention. The fishing rig 90 includes a fishing hook 92 that features a line attachment 94, a shank 96, a point 98, and a barb 99. The shank 96 features a substantially straight shaped portion starting with the line attachment 94, followed by a bend, which is then followed by a curve shaped portion which continues all the way to the point 98 of the hook 92. As pictured, the substantially straight shaped portion of the shank 96 is elongated. The fishing rig 90 further includes two identical floats 100 which are connected to the shank 96 via a tether 102 that is wrapped around the shank 96.

From the above description of preferred embodiments of the invention, those skilled in the art will perceive improvements, changes and modifications. Such improvements, changes and modifications within the skill of the art are intended to be covered by the appended claims.

In one aspect an apparatus is provided that in some embodiments present the bait to the fish in an optimal manner, relatively near the bottom of a lake, without causing the bait to be dragged along or to come into contact with the bottom of the lake. Some of the benefits of suspending a fishing rig and bait according to an apparatus and method of the present invention include a reduced likelihood of losing the bait, a reduced likelihood of getting the baited hook entangled and hung up on an underwater object, while improving the visibility and presentation of the bait to the fish.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A fishing rig comprising:
a bait hook having:
a shank;
a line attachment at the end of said shank; and
at least one float connected along said shank.

2. The fishing rig of claim 1 wherein said shank includes said line attachment, a substantially straight portion, an elbow bend, a curved portion and a point.

3. The fishing rig of claim 1 wherein said shank is elongated.

4. The fishing rig of claim 1 further comprising:
a bait pin, wherein said bait pin is connected to said shank and said at least one float interposes said line attachment and said bait pin.

5. The fishing rig of claim 1 wherein said float is comprised of closed cell polyethylene foam.

6. The fishing rig of claim 1 wherein said float is red.

7. A fishing rig comprising:
a hook having:
a shank;
a first line attachment at the end of said shank;
a second line attachment along said shank; and
at least one float connected to said second line attachment.

8. The fishing rig of claim 7 further comprising:
a bait pin, wherein said bait pin is connected to said second line attachment.

9. The fishing rig of claim 7 wherein said float is comprised of closed cell polyethylene foam.

10. The fishing rig of claim 7 wherein said float is attached to said second line attachment via a tether.

11. A fishing rig comprising:
a bait hook having:
a shank;
a line attachment at the end of said shank;
a shank extension having a line attachment at one end, wherein said shank extension overlaps said hook shank and is fastened thereto; and
at least one float connected along said shank extension.

12. The fishing rig of claim 11 further comprising:
a bait pin, wherein said bait pin is connected to said bait hook line attachment.

13. The fishing rig of claim 11 wherein said shank extension is comprised of stainless steel wire.

14. The fishing rig of claim 11 wherein said shank extension is wrapped around said shank.

15. The fishing rig of claim 11 wherein said shank extension is wrapped around said shank and extends through said hook line attachment.

16. A method of making a fishing rig comprising the steps of:
providing a bait hook having a shank, a line attachment at the end of said shank;
attaching a shank extension to said hook shank so that said shank extension overlaps said hook shank and is attached thereto; and
attaching at least one float to said shank extension.

17. A method of making a fishing rig comprising the steps of:
providing a bait hook having a shank, a line attachment at the end of said shank;
attaching a tether to said shank so that said tether is attached thereto; and
attaching at least one float to said tether.
